(19) United States
(12) Patent Application Publication
(10) Pub. No.: US 2021/0255845 A1
(43) Pub. Date: Aug. 19, 2021

(54) ON-BOARD UPDATE APPARATUS, PROGRAM, AND METHOD FOR UPDATING PROGRAM OR DATA

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Taro Itatsu, Yokkaichi-shi, Mie (JP)

(21) Appl. No.: 16/771,122

(22) PCT Filed: Nov. 28, 2018
(86) PCT No.: PCT/JP2018/043818

§ 371 Date: Jun. 9, 2020

(30) Foreign Application Priority Data
Dec. 11, 2017 (JP) 2017-237191

(51) Int. Cl. G06F 8/65

(52) U.S. Cl. CPC G06F 8/65

(57) ABSTRACT

An on-board update apparatus is an on-board update apparatus for performing a process for updating a program or data of an on-board ECU, the on-board update apparatus including: a receiving unit configured to receive update information on an update of the program or data; an obtaining unit configured to obtain, based on the update information received by the receiving unit, the program or data from a providing apparatus configured to provide the program or data; a storage unit configured to store a current program or data obtained from the on-board ECU in a predetermined storage area; and a transmitting unit configured to transmit, after the storage unit stores the current program or data, the program or data obtained by the obtaining unit to the on-board ECU.

### TECHNICAL FIELD

The present disclosure relates to an on-board update apparatus, a program, and a method for updating a program or data.

This application claims propriety based on Japanese Patent Application No. 2017-237191, filed on Dec. 11, 2017, and incorporates all the contents described in this Japanese Application.

### BACKGROUND ART

A vehicle is provided with ECUs (Electronic Control Units) for controlling power train system on-board devices used, for example, for controlling an engine, and ECUs for controlling body system on-board devices used, for example, for controlling an air conditioner. Each ECU includes an arithmetic processing unit such as an MPU, a rewritable nonvolatile storage unit such as a RAM, and a communication unit for communicating with other ECUs, and controls the on-board device by reading and executing a control program stored in the storage unit. Further, the vehicle is provided with a communication device including a wireless communication function. The vehicle can communicate with a program providing apparatus that is connected to a network outside the vehicle via the communication device, download (receive) a control program of an ECU from the program providing apparatus, and update the control program of the ECU.

When updating the control program of the ECU, the control program stored in the current ECU is overwritten with the downloaded new control program. If the update of the control program fails, a recovery process for returning to the original control program is required. For this reason, when updating a control program of an ECU, the update apparatus (relay apparatus) disclosed in Patent Document 1 downloads a control program of the same version as the control program (current data) stored in the current ECU, in addition to a new control program (new data) for updating.

### CITATION LIST

### Patent Documents

Patent Document 1: JP 2017-97851A

### SUMMARY OF INVENTION

An on-board update apparatus according to one aspect of the present disclosure is an on-board update apparatus for performing a process for updating a program or data of an on-board ECU, the on-board update apparatus including: a receiving unit configured to receive update information on an update of the program or data; an obtaining unit configured to obtain, based on the update information received by the receiving unit, the program or data from a providing apparatus configured to provide the program or data; a storage unit configured to store a current program or data obtained from the on-board ECU in a predetermined storage area; and a transmitting unit configured to transmit, after the storage unit stores the current program or data, the program or data obtained by the obtaining unit to the on-board ECU.

### BRIEF DESCRIPTION OF DRAWINGS

FIG. 1 is a schematic view showing a configuration of an on-board update system according to a first embodiment.

FIG. 2 is a block diagram showing a configuration of an on-board update apparatus and the like according to the first embodiment.

FIG. 3 is a flowchart showing a process of a control unit according to the first embodiment.

FIG. 4 is a flowchart showing a process of a control unit according to a second embodiment.

FIG. 5 is a block diagram showing a configuration of an on-board update apparatus and the like according to a third embodiment.

FIG. 6 is a flowchart showing a process of a control unit according to the third embodiment.

### DESCRIPTION OF EMBODIMENTS

### Problems to be Solved by Present Disclosure

The update apparatus of Patent document 1 has the problem that communication traffic increases, and communication cost and processing time increase, because new data and current data are received from the program providing apparatus.

An object of the present disclosure is to provide an on-board update apparatus and the like that can suppress communication traffic and efficiently update a program of an on-board ECU.

### Effects of Present Disclosure

According to the present disclosure, an on-board update apparatus and the like that can suppress communication traffic and efficiently update a program of an on-board ECU can be provided.

### DESCRIPTION OF EMBODIMENTS OF PRESENT DISCLOSURE

First, aspects of the present disclosure will be listed and described. Further, at least some of the embodiments described below may be optionally combined.

(1) An on-board update apparatus according to one aspect of the present disclosure is an on-board update apparatus for performing a process for updating a program or data of an on-board ECU, the on-board update apparatus including: a receiving unit configured to receive update information on an update of the program or data; an obtaining unit configured to obtain, based on the update information received by the receiving unit, the program or the data from a providing apparatus configured to provide the program or data; a storage unit configured to store a current program or data obtained from the on-board ECU in a predetermined storage area; and a transmitting unit configured to transmit, after the storage unit stores the current program or data, the program or data obtained by the obtaining unit to the on-board ECU.

According to this aspect, the on-board update apparatus transmits, after storing the current program or data of the on-board ECU to be updated in the predetermined storage area, the obtained program or data to the on-board ECU. Accordingly, it is not necessary to obtain the current program or data of the on-board ECU to be updated from the providing apparatus, and the communication cost and processing time can be reduced.

(2) Preferably, the on-board update apparatus further includes a load detection unit configured to detect a load of the on-board ECU or a load of an in-vehicle network for communicating with the on-board ECU, and if the load detected by the load detection unit is smaller than or equal to a predetermined value, the storage unit stores the current program or data in the storage area.

According to this aspect, if the load detected by the load detection unit is smaller than or equal to the predetermined value, the current program or data is stored in the storage area. Accordingly, if the load is large, it is possible to suppress a further load for storing the current program or data, and the process for storing the current program or data in the storage area can be reliably performed.

(3) Preferably, if the load becomes larger than the predetermined value while the current program or data is being stored in the predetermined storage area, the storage unit interrupts the storage of the current program or data, and after the interruption, if the load becomes smaller than or equal to the predetermined value, the storage unit resumes storing the current program or data.

According to this aspect, if the load becomes larger than the predetermined value while the current program or data is being stored in the predetermined storage area, the process of storing the current program or data is interrupted, so that the load can be reduced. Then, if the load becomes smaller than or equal to the predetermined value after the interruption of the storing process, the process of storing the current program or data is resumed, so that the process of storing the current program or data in the storage area can be reliably completed.

(4) Preferably, the on-board update apparatus further includes a deletion unit configured to delete, after the transmitting unit transmits the program or data to the on-board ECU, the current program or data stored in the storage area.

According to this aspect, the current program or data stored in the storage area is deleted after the program or data is transmitted to the on-board ECU, so that a possibility that the current program or data is leaked can be reduced.

(5) Preferably, the storage area is provided in a relay apparatus for communicating with the providing apparatus.

According to this aspect, the storage area is provided in the relay apparatus for communicating with the providing apparatus, so that the storage area of the relay apparatus can be effectively used.

(6) Preferably, the storage area is provided in a second on-board ECU having a storage area for backup.

According to this aspect, the storage area is provided in the second on-board ECU having the storage area for backup, so that the storage area for backup of the second on-board ECU can be effectively utilized.

(7) A program according to one aspect of the present disclosure causes a computer to execute the processes of: receiving update information on an update of a program or data; obtaining, based on the received update information, the program or data from a providing apparatus configured to provide the program or data; storing a current program or data obtained from an on-board ECU to be updated in a predetermined storage area; and transmitting, after the current program or data is stored, the obtained program or data to the on-board ECU.

According to this aspect, the computer can function as an on-board update apparatus according to one aspect of the present disclosure.

(8) A method for updating a program or data according to one aspect of the present disclosure including: receiving update information on an update of a program or data; obtaining, based on the received update information, the program or data from a providing apparatus configured to provide the program or data; storing a current program or data obtained from an on-board ECU to be updated in a predetermined storage area; and transmitting, after the current program or data is stored, the obtained program or data to the on-board ECU.

According to this aspect, after the current program or data of an on-board ECU of the present embodiment is stored in the predetermined storage area, the obtained program or data is transmitted to the on-board ECU. Accordingly, it is not necessary to obtain the current program or data of the on-board ECU to be updated from the providing apparatus, and a method for updating a program or data, which can reduce the communication cost and processing time, can be provided.

### DETAILS OF EMBODIMENTS OF PRESENT DISCLOSURE

The present disclosure will be specifically described with reference to the drawings illustrating the embodiments. An on-board update apparatus 2 according to the embodiments of the present disclosure will be described below with reference to the drawings. Note, that the present disclosure is not limited to these exemplifications, but is indicated by the scope of the claims, and is intended to include meanings equivalent to the scope of the claims and all modifications within the scope.

### First Embodiment

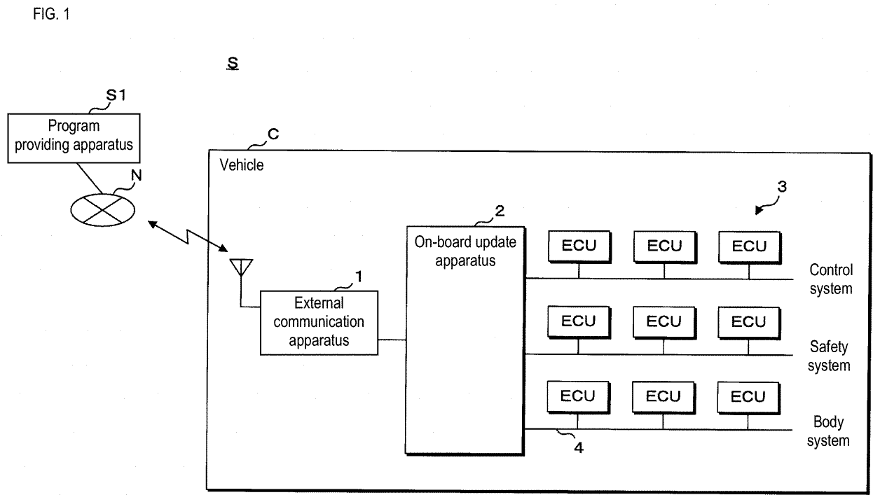

Hereinafter, an embodiment will be described with reference to the drawings. FIG. 1 is a schematic view showing a configuration of an on-board update system S according to a first embodiment. The on-board update system S includes an external communication apparatus 1 and an on-board update apparatus 2 installed on a vehicle C, and transmits a program or data obtained from a program providing apparatus S1 that is connected via an external network N to a first on-board ECU 3 (Electronic Control Unit) installed in the vehicle C.

The program providing apparatus S1 is, for example, a computer such as a server that is connected to the external network N such as the Internet or a public telephone network. The program providing apparatus S1 stores a program or data, which was created by the manufacturer or the like of the first on-board ECU 3, for controlling the first on-board ECU 3. The program or data is transmitted to the vehicle C as described later, and is used to update a program or data of the first on-board ECU 3 that is installed in the vehicle C.

The vehicle C is provided with the external communication apparatus 1, the on-board update apparatus 2, and a plurality of first on-board ECUs 3 for controlling various on-board devices. The external communication apparatus 1, the on-board update apparatus 2, and the first on-board ECUs 3 are communicably connected by an in-vehicle LAN 4.

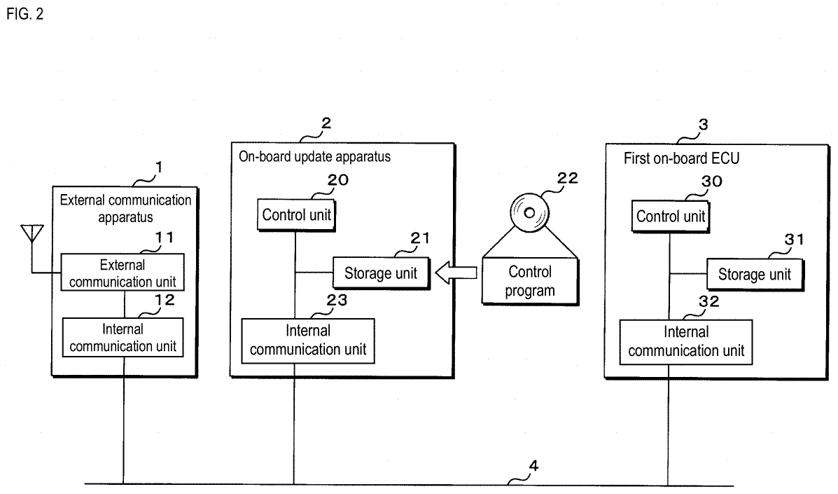

FIG. 2 is a block diagram showing a configuration of an on-board update apparatus 2 and the like according to the first embodiment. The on-board update apparatus 2 includes a control unit 20, a storage unit 21, and an internal communication unit 23. The on-board update apparatus 2 is configured to obtain the program or data that the external communication apparatus 1 has received from the program providing apparatus S1 thorough wireless communication via the in-vehicle LAN 4, and to transmit the program or data to a predetermined first on-board ECU 3. The on-board update apparatus 2 is, for example, a central gateway (CGW/relay device) that controls segments of the systems of the plurality of first on-board ECUs 3, such as a control system, a safety system, and a body system. Alternatively, the on-board update apparatus 2 may also be a body ECU that controls the entire vehicle C.

The control unit 20 is configured by a CPU (Central Processing Unit), an MPU (Micro Processing Unit), or the like, and performs various control processes and arithmetic processes by reading and executing a control program or data that is stored in the storage unit 21 in advance. The control unit 20 functions as a load detection unit or a deletion unit, by executing the control program. The control unit 20 functions as a receiving unit and an obtaining unit, by operating through the external communication apparatus 1 or the internal communication unit 23. The control unit 20 functions as a transmitting unit, by operating through the internal communication unit 23.

The storage unit 21 is configured by a volatile memory element such as a RAM (Random Access Memory) or a non-volatile memory element such as a ROM (Read Only Memory), an EEPROM (Electrically Erasable Programmable ROM), or a flash memory, and stores the control program and the data to be referred to at the time of processing in advance. The control program stored in the storage unit 21 may also be a control program that is read by the on-board update apparatus 2 from a readable storage medium 22. Also, the control program stored in the storage unit 21 may also be a control program that is downloaded from an external computer (not shown) connected to a communication network (not shown), and that is stored in the storage unit 21. Although the details will be described later, the storage unit 21 stores the obtained program or data.

The internal communication unit 23 is an input/output interface using a communication protocol such as CAN (Control Area Network), LIN (Local Interconnect Network), or Ethernet (registered trademark), and communicates with the on-board devices, such as the external communication apparatus 1 and the first on-board ECUs 3, that are connected to the in-vehicle LAN 4.

Note, that the control unit 20 and the storage unit 21 may also be units that are distributed to the plurality of on-board devices such as the CGW and the body ECU, and that function by cooperating with each other or working together, thorough mutual communication.

The external communication apparatus 1 includes an external communication unit 11 and an internal communication unit 12. The external communication unit 11 is an input/output interface for performing wireless communication using a mobile communication protocol such as 3G, LTE, 4G, and WiFi, and communicates with a program providing apparatus S1 via an external network such as a public telephone network or the Internet.

The internal communication unit 12 has the same function as the internal communication unit 23 of the on-board update apparatus 2, and communicates with the on-board update apparatus 2 and the like via the in-vehicle LAN 4.

In this embodiment, the external communication apparatus 1 is a device different from the on-board update apparatus 2, and these devices are communicably connected by the in-vehicle LAN 4, but the present invention is not limited to this. The external communication apparatus 1 may also be built into the on-board update apparatus 2, as a component of the on-board update apparatus 2.

The first on-board ECU 3 includes a storage unit 31, a control unit 30, and an internal communication unit 32. The storage unit 31 is configured by a volatile memory element such as a RAM (Random Access Memory) or a non-volatile memory element such as a ROM (Read Only Memory), an EEPROM (Electrically Erasable Programmable ROM), or a flash memory, and stores the program or data of the first on-board ECU 3. This program or data is to be updated by the on-board update apparatus 2.

The storage capacity of the storage unit 31 is set, based on the size of the program or data. Accordingly, the storage unit 31 has a storage area for storing the program or data, but has no storage area for backing up the program or data.

The control unit 30 is configured by a CPU (Central Processing Unit), an MPU (Micro Processing Unit), or the like, reads and executes the program and data stored in advance in the storage unit 31 to perform control processing and the like, and controls the on-board devices including the first on-board ECU 3 or an actuator or the like. Although details will be described later, the control unit 30 obtains the program or data transmitted from the on-board update apparatus 2, and updates the current program or data stored in the storage unit 31 to the obtained program or data. The control unit 30 transmits the program or data stored in the storage unit 31 to the on-board update apparatus 2, based on an instruction from the on-board update apparatus 2.

The internal communication unit 32 has the same function as the internal communication unit 23 of the on-board update apparatus 2, and communicates with the on-board update apparatus 2 and the like via the in-vehicle LAN 4.

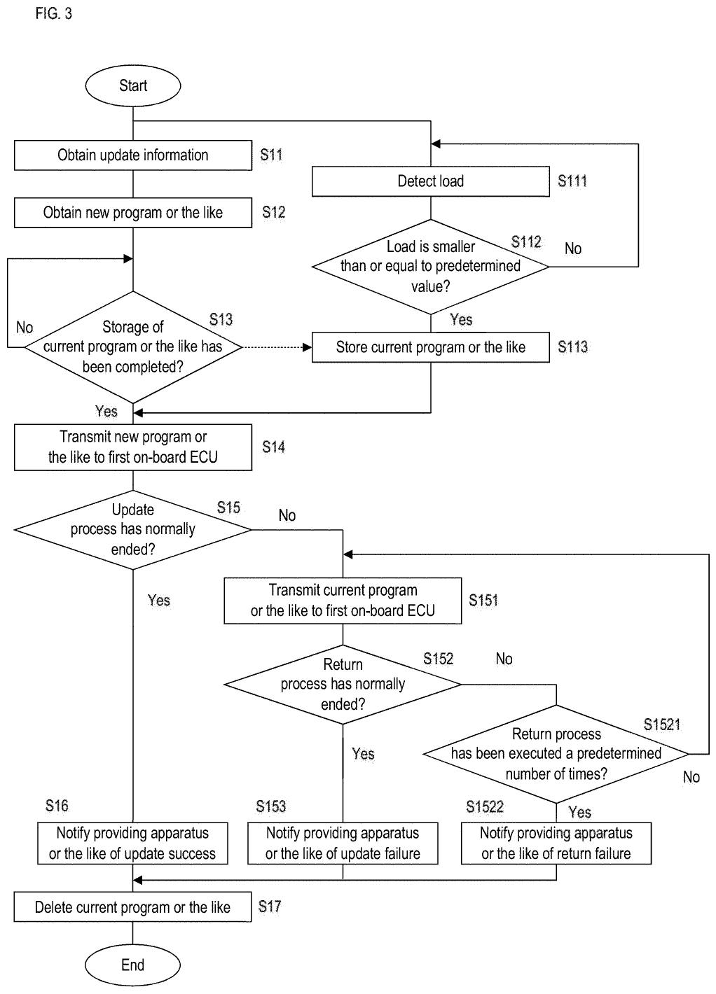

FIG. 3 is a flowchart showing a process of the control unit 20 according to the first embodiment. The control unit 20 of the on-board update apparatus 2 regularly or irregularly communicates with the program providing apparatus S1 via the external communication apparatus 1, and executes the following processes.

The control unit 20 obtains update information on an update of the program or the like of the first on-board ECU 3 to be updated (step S11). The update information is information for notifying that the update program or the like is ready, if a new program or the like (an update program or the like) for updating the program or the like of the first on-board ECU 3 is ready in the program providing apparatus S1. The control unit 20 communicates with the program providing apparatus S1 via the external communication apparatus 1, and obtains the update information concerning the program or the like of the first on-board ECU 3. The communication between the control unit 20 and the program providing apparatus S1 is performed, for example, by the control unit 20 regularly accessing (polling) the program providing apparatus S1 to confirm whether or not there is update information. Alternatively, the control unit 20 may also obtain update information concerning a program or the like by receiving a notification concerning the update information from the program providing apparatus S1.

The control unit 20 obtains a program or the like (a new program or the like) of the first on-board ECU 3 from the program providing apparatus S1 (step S12). The new program or the like is a program or the like (an update program or the like) for updating the program or the like of the first on-board ECU 3 by applying the new program or the like to the first on-board ECU 3 to be updated. The control unit 20 stores the obtained new program in the storage unit 21.

In parallel with the processing of step S12, the control unit 20 detects a load such as a load of the control unit 20 of the first on-board ECU 3, or a network load of the in-vehicle LAN 4 for communicating with the first on-board ECU 3 (step S111). The control unit 20 generates a sub process to detect this load. Alternatively, a process for detecting the load may also be generated in advance, and the process for detecting the load may also be activated to perform processing by performing inter-process communication such as sending a signal to the process.

The control unit 20 determines whether the detected load is smaller than or equal to a predetermined value (step S112). When detecting the load of the control unit 20 of the first on-board ECU 3, the control unit 20 communicates with the first on-board ECU 3 via the internal communication unit 23, and detects a processing load applied to the control unit 30, such as the MPU of the first on-board ECU 3. When detecting the network load of the in-vehicle LAN 4, the control unit 20 monitors the traffic and the like of the in-vehicle LAN 4, and detects a load based on the network usage rate and the like. The predetermined value is appropriately determined based on, for example, the frequency performance of the control unit 20 such as the MPU of the first on-board ECU 3 or the bandwidth of the in-vehicle LAN 4, and for example, about 50% is determined as the predetermined value.

If the detected load is smaller than or equal to the predetermined value (YES in step S112), the control unit 20 obtains the program or the like (the current program or the like) that is currently applied to the first on-board ECU 3 from the first on-board ECU 3, and stores the obtained current program or the like in the storage unit 21 (step S113). The control unit 20 stores the current program or the like in the storage unit 21 that belongs to its on-board update apparatus 2, so that the current program or the like can be reliably stored in the predetermined storage area.

Cases where the detected load is smaller than or equal to the predetermined value include cases where the ignition power supply of the vehicle C is turned off. Accordingly, even if the ignition power supply of the vehicle C is turned off while the control unit 20 is obtaining the current program or the like from the first on-board ECU 3, or while the control unit 20 is storing the current program or the like in the storage unit 21, the control unit 20 continues the process of obtaining the current program or the like or storing the current program or the like in the storage unit 21.

If the detected load is not smaller than or equal to the predetermined value (NO in step S112), that is to say, if the detected load is larger than the predetermined value, a loop process is performed to execute the processing of step S111 again.

After executing the process of step S12, the control unit 20 determines whether the storage of the current program or the like as the sub process has been completed (step S13). When the storage of the current program or the like (step S113) has been completed, the control unit 20 makes the determination based on, for example, a signal transmitted by the sub process. Alternatively, the control unit 20 may also make the determination, by reading the current program stored in the storage unit 21.

If the storage of the current program or the like has not been completed (NO in step S13), the control unit 20 performs a loop process to perform the determination of step S13 again. In performing the loop process, the control unit 20 may also execute a standby process (sleep) for a predetermined time.

If the storage of the current program or the like has been completed (YES in step S13), the control unit 20 reads the new program or the like stored in the storage unit 21, and transmits the new program or the like to the first on-board ECU 3 via the internal communication unit 23.

The control unit 20 determines whether the first on-board ECU 3 to which the new program or the like has been transmitted has normally ended the update process using the new program or the like (step S15). The first on-board ECU 3 is configured to receive the transmitted new program or the like, and update the current program or the like to the new program or the like by overwriting the current program or the like stored in the storage unit 31. Accordingly, the control unit 20 determines whether the update process has normally ended, for example, by communicating with the first on-board ECU 3.

If the update process has normally ended (YES in step S15), the control unit 20 notifies the program providing apparatus S1 of the update success via the external communication apparatus 1 (step S16). The control unit 20 may also further notify the operator of the vehicle C of the update success via a notification unit (not shown) such as a speaker or a display provided in the vehicle C.

If the update process has not been normally ended (YES in step S15), that is to say, if the update process has been abnormally ended, the control unit 20 reads the current program or the like stored in the storage unit 21, and transmits the current program or the like to the first on-board ECU 3 (step S151).

The control unit 20 determines whether the first on-board ECU 3 to which the current program or the like has been transmitted has normally ended the return process using the current program or the like (step S152). The first on-board ECU 3 is configured to receive the transmitted current program or the like, and to perform the return process from a state where the current program or the like is being updated to the new program or the like, to a state where the current program or the like is applied. Accordingly, the control unit 20 determines whether the return process has normally ended, for example, by communicating with the first on-board ECU 3.

If the return process has normally ended (YES in step S152), the control unit 20 notifies the program providing apparatus S1 of the update failure via the external communication apparatus 1 (step S153). The control unit 20 may also further notify the operator of the vehicle C of the update failure via the notification unit (not shown) such as the speaker and the display provided in the vehicle C. The notification of the update failure means that the update to the new program or the like has failed, but the return process to return to the current program or the like has succeeded.

If the return process has not normally ended (NO in step S152), the control unit 20 determines whether the return process has been executed a predetermined number of times (step S1521). The number of times is counted by, for example, a counter process of setting an initial value and increasing the initial value according to the number of loops (the number of retries). The control unit 20 counts the number of retries of the return process, and determines whether the number of retries has reached a predetermined number of times. The predetermined number of times is set to, for example, about five times.

If the return process has not been executed the predetermined number of times (NO in step S1521), the control unit 20 performs a loop process to execute the process of step S151 again.

If the return process has been executed the predetermined number of times (YES in step S1521), the control unit 20 notifies the program providing apparatus S1 of the return failure via the external communication apparatus 1 (step S1522). The control unit 20 may also further notify the operator of the vehicle C of the return failure via the notification unit (not shown) such as the speaker and the display provided in the vehicle C. The notification of the return failure means that the update to the new program or the like has failed, and the process of returning to the current program or the like has also failed.

After performing the processes of steps S16, S153, and S1522, the control unit 20 deletes the current program or the like stored in the storage unit 21 (step S17).

Because the current program or the like of the first on-board ECU 3 to be updated is obtained from the first on-board ECU 3 and stored in the storage unit 21, it is not necessary to communicate with the program providing apparatus S1 to obtain the current program or the like. Accordingly, the communication amount with the program providing apparatus S1 can be diminished, and the communication cost and the processing time can be reduced.

The control unit 20 detects the load of the first on-board ECU 3 to be updated or the load of the in-vehicle LAN 4 for communicating with the first on-board ECU 3. Then, if the load is smaller than or equal to the predetermined value, the control unit 20 obtains the current program or the like from the first on-board ECU 3, and stores the obtained current program or the like in the storage unit 21. Accordingly, if the load is large, it is possible to diminish a further load for storing the current program or data, and the process for storing the current program or data in the storage unit 21 can be reliably performed.

After obtaining the update information, the control unit 20 performs the process of obtaining the new program or the like from the program providing apparatus S1 and the process of obtaining the current program or the like from the first on-board ECU 3 in parallel. Therefore, the processing time can be shortened.

In the present embodiment, the process of obtaining the new program or the like from the program providing apparatus S1 and the process of obtaining the current program or the like from the first on-board ECU 3 are performed in parallel, but the present invention is not limited to this. The control unit 20 may also obtain the current program or the like from the first on-board ECU 3, after obtaining the new program or the like from the program providing apparatus S1. Also, the control unit 20 may also obtain the new program or the like from the program providing apparatus S1, after obtaining the current program or the like from the first on-board ECU 3.

### Second Embodiment

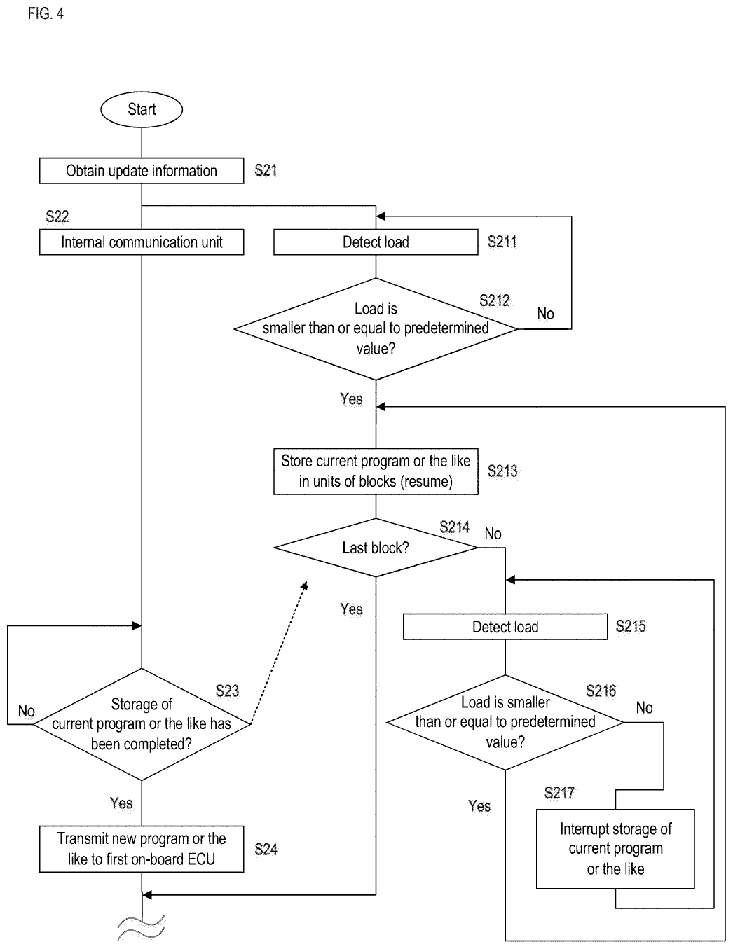

FIG. 4 is a flowchart showing a process of a control unit 20 according to a second embodiment. The control unit 20 of an on-board update apparatus 2 according to the second embodiment is different from the control unit 20 of the on-board update apparatus 2 according to the first embodiment, in that, for example, the control unit 20 detects a load even while the current program or the like is being stored, and the process is interrupted if the load is not smaller than or equal to the predetermined value. The following mainly describes such differences. The processes from step S21 to step S24 are the same as the processes from step S11 to step S14 in the first embodiment, and thus their description is omitted. The processes of steps S211 and S212 are the same as the steps S111 and S112 in the first embodiment, and thus their description is omitted. Also, the processes after step S24 are the same as the processes after step S15 in the first embodiment, and thus their description is omitted.

If the detected load is smaller than or equal to the predetermined value (YES in step S212), the control unit 20 obtains the program or the like (the current program or the like) that is currently applied to the first on-board ECU 3 from the first on-board ECU 3, and stores the obtained current program or the like in the storage unit 21 in block units (step S213). A block is data obtained by dividing the current program or the like by a predetermined data size. Alternatively, the control unit 20 may also extract a separator included in the current program or the like, and divide the current program or the like into blocks based on the separator.

The control unit 20 determines whether the stored block is the last block (step S214). If the stored block is not the last block (NO in step S214), as in the process of step S211, the control unit 20 detects a load such as the load of the control unit 30 of the first on-board ECU 3, or the network load of the in-vehicle LAN 4 for communicating with the first on-board ECU 3 (step S215).

The control unit 20 determines whether the detected load is smaller than or equal to the predetermined value (step S216). If the detected load is not smaller than or equal to the predetermined value (NO in step S216), that is to say, if the load is larger than the predetermined value, the control unit 20 interrupts the process of storing the current program or the like (step S217). The control unit 20 interrupts the communication for obtaining the current program or the like from the first on-board ECU 3. After the interruption, the control unit 20 performs a loop process to execute the process of step S215 again. The control unit 20 continues the process of detecting the load, by performing the loop process.

If the detected load is smaller than or equal to the predetermined value (YES in step S216), the control unit 20 performs a loop process to execute the process of step S213 again. If the communication with the first on-board ECU 3 and the process of storing the current program or the like have already been interrupted, the communication with the first on-board ECU 3 and the process of storing the current program or the like are resumed by executing the process of step S213 again (step S213).

If the stored block is the last block (YES in step S214), the control unit 20 determines that the storage of the current program or the like have been completed (YES in step S23), and performs the processes after step S24 as in the first embodiment.

It is possible to suppress a further increase in the load on the first on-board ECU 3 or the in-vehicle LAN 4 by interrupting or resuming the process or the like of storing the current program or the like, according to the load of the first on-board ECU 3 or the in-vehicle LAN 4, while the current program or the like is obtained from the first on-board ECU 3 and stored in the storage unit 21. Accordingly, the program or the like can be reliably stored in the storage unit 21. Because the storage of the current program or the like is performed in units of blocks, it is possible to resume the storage, based on the number, such as the ID of the block, provided when the storage was interrupted.

In the present embodiment, the storage of the current program or the like is a sequential process in which the storage of the current program or the like is performed in units of blocks, then the load is detected, and the process such as the storage is interrupted or resumed according to the detected load. However, the present invention is not limited to this. The control unit 20 may also generate a sub process for monitoring the load of the first on-board ECU 3 or the in-vehicle LAN 4, in parallel with the process of obtaining the current program or the like from the first on-board ECU 3 and storing the obtained current program or the like in the storage unit 21. The control unit 20 may also monitor the load through the generated sub process, perform inter-process communication such as sending a signal to a process of storing the current program or the like if the load is larger than the predetermined value, or if the load is smaller than or equal to the predetermined value, and interrupt or resume the process or the like of storing the current program or the like.

### Third Embodiment

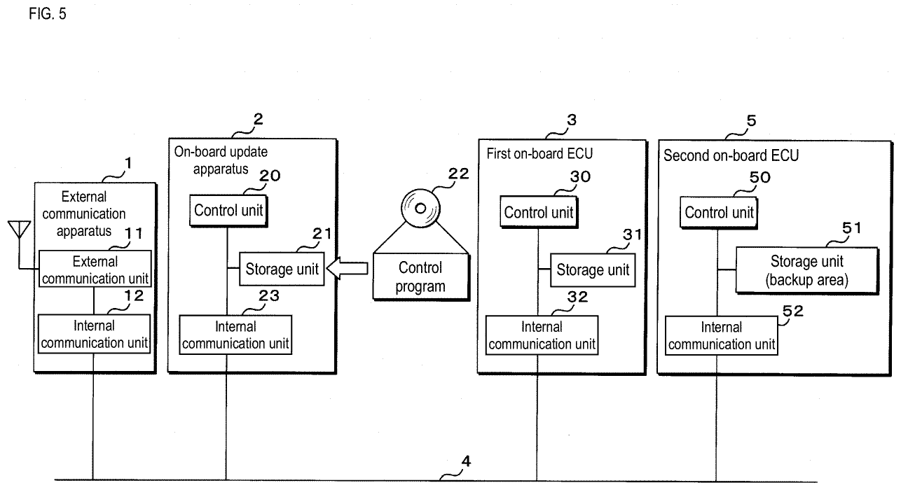

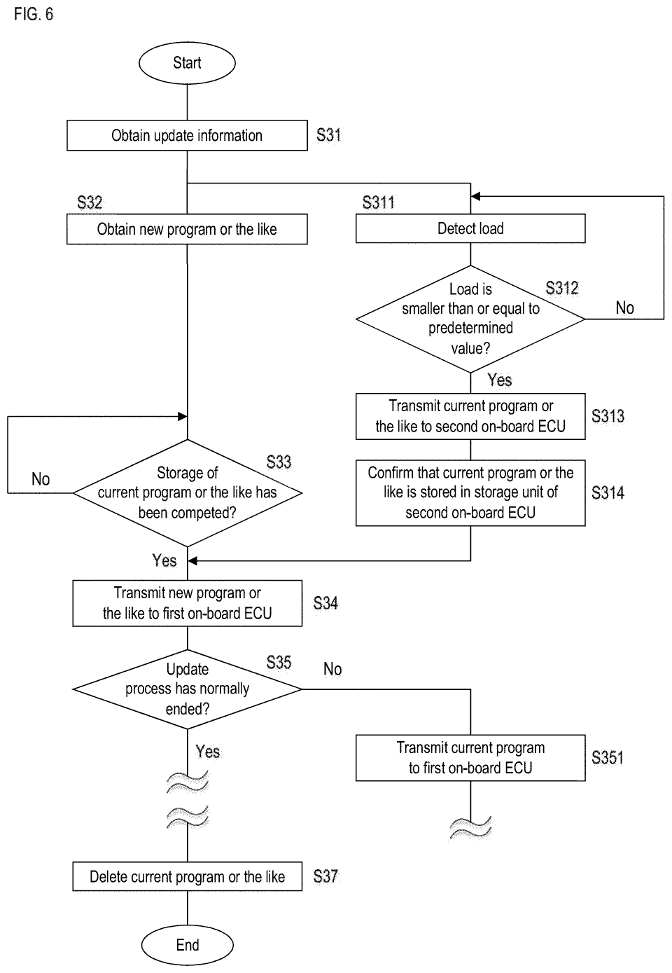

FIG. 5 is a schematic view showing a configuration of an on-board update system S according to a third embodiment. FIG. 6 is a flowchart showing a process of a control unit 20 according to the third embodiment. The control unit 20 of an on-board update apparatus 2 according to the third embodiment is different from the control unit 20 of the on-board update apparatus 2 according to the first embodiment, in that the control unit 20 stores the current program or the like of the first on-board ECU 3 in a storage unit 51 of a second on-board ECU 5. The following mainly describes such differences.

The on-board update system S includes, as in the first embodiment, the external communication apparatus 1, the on-board update apparatus 2, and the first on-board ECU 3, and further includes the second on-board ECU 5.

The second on-board ECU 5 includes a storage unit 51, a control unit 50, and an internal communication unit 52. The storage unit 51 is configured by a volatile memory element such as a RAM (Random Access Memory) or a non-volatile memory element such as a ROM (Read Only Memory), an EEPROM (Electrically erasable Programmable ROM), or a flash memory, and stores the program or data of the second on-board ECU 5.

The storage capacity of the storage unit 51 includes, in addition to a capacity for storing a program or data, a capacity for storing backup of the program or data. Accordingly, the storage unit 51 has, in addition to a storage area for storing the program or data, a storage area (a backup area) for backing up the program or data.

The control unit 50 is configured by a CPU (Central Processing Unit), an MPU (Micro Processing Unit), or the like, reads and executes the program and data stored in advance in the storage unit 51 to perform control processing and the like, and controls the on-board devices including the second on-board ECU 5 or an actuator or the like. Although the details will be described later, the control unit 50 stores the current program or the like of the first on-board ECU 3 transmitted from the on-board update apparatus 2 in the backup area of the storage unit 51.

The internal communication unit 52 has the same function as the internal communication unit 23 of the on-board update apparatus 2, and communicates with the on-board update apparatus 2 and the like via the in-vehicle LAN 4.

The processes from step S31 to step S34 are the same as the processes from step S11 to step S14 in the first embodiment, and thus their description is omitted. Also, the processes after step S34 are the same as the processes after step S14 in the first embodiment, and thus their description is omitted.

The control unit 20 detects a load such as the load of the control unit 30 of the first on-board ECU 3, the load of the control unit 50 of the second on-board ECU 5, or the network load of the in-vehicle LAN 4 for communicating with these on-board ECUs (step S311). The load of the second on-board ECU 5 is detected by the same method as the method for detecting the load of the first on-board ECU 3 in the first embodiment.

As in the first embodiment, the control unit 20 determines whether the load is smaller than or equal to the predetermined value (step S312). If the detected load is not smaller than or equal to the predetermined value (NO in step S312), that is to say, if the detected load is larger than the predetermined value, a loop process is performed to execute the process of step S311 again.

If the detected load is smaller than or equal to the predetermined value (YES in step S312), the control unit 20 obtains the program or the like (the current program or the like) that is currently applied to the first on-board ECU 3 from the first on-board ECU 3, and stores the obtained current program or the like in the second on-board ECU 5 (step S313). The second on-board ECU 5 is configured to receive the transmitted current program or the like, and to store the current program or the like in the backup area of the storage unit 51 of the second on-board ECU 5.

By communicating with the second on-board ECU 5, the control unit 20 confirms that the current program or the like has been stored in the storage unit 51 (the backup area) of the second on-board ECU 5 (step S314).

The control unit 20 executes the processes of the steps S33 to S35, as in the first embodiment. In the process of step S35, if the update process has not normally ended (NO in step S35), the control unit 20 obtains the current program or the like from the second on-board ECU 5, and transmits the current program or the like to the first on-board ECU 3 (step S351).

After transmitting a notification or the like to the program providing apparatus S1 as in steps S16, S153, and S 1522 in the first embodiment, the control unit 20 deletes the current program or the like stored in the storage unit 51 of the second on-board ECU 5 (step S37). The control unit 20 communicates with the second on-board ECU 5, and outputs an instruction to the second on-board ECU 5 to delete the current program or the like. Based on the instruction from the control unit 20, the second on-board ECU 5 deletes the current program or the like stored in the backup area of the storage unit 51.

Tightening of the storage area of the storage unit 21 of the on-board update apparatus 2 can be suppressed, by storing the current program or the like of the first on-board ECU 3 to be updated in the backup area of the storage unit 51 of the second on-board ECU 5.

The embodiments disclosed this time are to be considered in all respects as illustrative, and not restrictive. The scope of the present invention is defined by the terms of the claims, rather than the description above, and is intended to include any modifications within scope and meaning equivalent to the terms of the claims.

### LIST OF REFERENCE NUMERALS

C Vehicle
S On-board update system
S1 Program providing apparatus (Providing apparatus)
1 External communication apparatus
11 External communication unit
12 Internal communication unit
2 On-board update apparatus (Relay apparatus, CGW)
20 Control unit (Receiving unit, Obtaining unit, Transmitting unit, Load detection unit, Deletion unit)
21 Storage unit
22 Storage medium
23 Internal communication unit
3 First on-board ECU (On-board ECU)
30 Control unit
31 Storage unit
32 Internal communication unit
4 In-vehicle LAN (In-vehicle network)
5 Second on-board ECU
50 Control unit
51 Storage unit (Backup area)
52 Internal communication unit

1. An on-board update apparatus for performing a process for updating a program or data of an on-board ECU, the on-board update apparatus comprising:
a receiving unit configured to receive update information on an update of the program or data;
an obtaining unit configured to obtain, based on the update information received by the receiving unit, the program or data from a providing apparatus configured to provide the program or data;
a storage unit configured to store a current program or data obtained from the on-board ECU in a predetermined storage area; and
a transmitting unit configured to transmit, after the storage unit stores the current program or data, the program or data obtained by the obtaining unit to the on-board ECU.

2. The on-board update apparatus according to claim 1, further comprising:
a load detection unit configured to detect a load of the on-board ECU or a load of an in-vehicle network for communicating with the on-board ECU,
wherein, if the load detected by the load detection unit is smaller than or equal to a predetermined value, the storage unit stores the current program or data in the storage area.

3. The on-board update apparatus according to claim 2,
wherein, if the load becomes larger than the predetermined value while the current program or data is being stored in the predetermined storage area, the storage unit interrupts the storage of the current program or data, and after the interruption, if the load becomes smaller than or equal to the predetermined value, the storage unit resumes storing the current program or data.

4. The on-board update apparatus according to any one of claims 1 to 3, further comprising:
a deletion unit configured to delete, after the transmitting unit transmits the program or data to the on-board ECU, the current program or data stored in the storage area.

5. The on-board update apparatus according to any one of claims 1 to 4,
wherein the storage area is provided in a relay apparatus for communicating with the providing apparatus.

6. The on-board update apparatus according to any one of claims 1 to 4,
wherein the storage area is provided in a second on-board ECU having a storage area for backup.

7. A program that causes a computer to execute the processes of:
receiving update information on an update of a program or data;
obtaining, based on the received update information, the program or data from a providing apparatus configured to provide the program or data;
storing a current program or data obtained from an on-board ECU to be updated in a predetermined storage area; and
transmitting, after the current program or data is stored, the obtained program or data to the on-board ECU.

8. A method for updating a program or data comprising:
receiving update information on an update of a program or data;
obtaining, based on the received update information, the program or data from a providing apparatus configured to provide the program or data;
storing a current program or data obtained from an on-board ECU to be updated in a predetermined storage area; and
transmitting, after the current program or data is stored, the obtained program or data to the on-board ECU.
